(19) United States
(12) Patent Application Publication
(10) Pub. No.: US 2006/0018520 A1
(43) Pub. Date: Jan. 26, 2006

(54) Biometric-supported name-based criminal history background checks

(75) Inventor: Robert W. Holloran, Ocala, FL (US)

Correspondence Address: Douglas Wm. Massinger, Esquire;MASSINGER LAW OFFICES, 887 N.E. 100 th Street, Ocala, FL, 34479, US

(73) Assignee: National Background Data, LLC

(21) Appl. No.: 11/187,391

(22) Filed: Jul. 21, 2005

Related U.S. Application Data
(60) Provisional application No. 60/590,292, filed on Jul. 21, 2004.

(51) Int. Cl. G06K 9/00

(52) U.S. Cl. 382/116

(57) ABSTRACT

A method and apparatus for conducting biometric-supported name-based criminal history background investigations is disclosed as a means of eliminating both false-positive and false-negative results. Each of the embodiments disclosed employ the cooperative efforts of a professional background screening company, a database compiler, a trusted independent third-party evaluator of biometric data, and at least one government criminal history repository for providing more accurate screening reports for employers.

### CROSS REFERENCE TO RELATED APPLICATION

This application claims the benefit of U.S. Provisional Patent Application No. 60/590,292 filed on Jul. 21, 2004 entitled Biometric Evaluation Of Personal Information-Based Criminal Background Search Results.

### FIELD OF THE INVENTION

The subject invention relates to criminal background investigations in general, and to the biometric evaluation of personal information-based criminal background search results in particular.

### BACKGROUND OF THE INVENTION

Only two basic methods of performing criminal background investigations are currently in use: (1) fingerprint-based checks and (2) name-based checks. Each suffer from various shortcomings and limitations as set forth in detail below. The subject invention relates to a new criminal history background check method that uses biometrics (a fingerprint and/or a digital photograph) to enhance the identification accuracy of name-based checks and to obviate the shortcomings and limitations of the prior art.

A criminal history record misattributed to an applicant is called a “false positive”. False positives may result when: (1) the applicant has a common name, such as, John Smith, (2) when the applicant's identity has been stolen and used when the offender was booked or (3) limited date of birth information is available. The Fair Credit Reporting Act (FCRA) requires Consumer Reporting Agencies (CRAs) to “follow reasonable procedures to assure maximum possible accuracy of the information concerning the individual about whom the report relates.”

To reduce the potential for “false positives” some organizations limit name-based criminal history checks of available multi-state criminal history databases to “exact matches” of applicants' names and dates of births. This practice increases the potential for missing criminal history records that actually apply to the applicant, but for which there was not an exact match between the applicant's data and the offender's data maintained by the repository. For example, the order of the month and day in the date of birth may be reversed—Feb. 5, 1965 versus May 2, 1965, or a name might be misspelled, for example, Halloran instead of Holloran. Whether as a result of deception, or simply a clerical error, relying on exact matches would miss records that include these types of erroneous information.

Advanced matching logic is available that would return records with these types of errors. However, use of this logic increases the potential for “false positives”. The availability of a reliable means of eliminating false positives would permit increased use of these techniques.

Criminal history background checks are also conducted on prospective volunteers. Private sector volunteer screenings currently are name checks enhanced with residence checks and SSN verifications. These name checks can be automated to implement the “reasonable procedures” required by the Fair Credit Reporting Act (FCRA) to “assure maximum possible accuracy of the information concerning the individual about whom the report relates.”

Public-private partnerships are a way to extend the array of options for making background checks of volunteers more effective and efficient. High cost, inconvenience and privacy concerns are barriers to broader acceptance of background checks of volunteers. New types of volunteer centric background check products can be created through private sector criminal history database compilers and third-party biometric repositories which work with the public sector's state and federal criminal history repositories.

Many of the barriers to the use of fingerprint-based checks of volunteers can be addressed if the volunteers initiate these checks through an independent, trusted third party biometric repository. These checks are periodically updated with commercial name-based checks. After the volunteers are satisfied that the results of these checks are accurate and complete, the volunteers can present the results to volunteer organizations as evidence of their suitability to work with children and other vulnerable populations. Through the third-party repository, the volunteer organizations can confirm both that the presented results are authentic and that the checks were based upon the volunteers' fingerprints.

There exist additional types of public-private partnerships that can increase security, while protecting individuals' privacy and generating additional operating revenues for the repositories.

### Private Sector Volunteer Checks

The private sector is conducting large numbers of criminal background checks for volunteers. The low cost of private sector screenings of volunteers (typically about $2.50) has been the primary reason that most volunteer organizations have been relying on them in lieu of much more expensive fingerprint-based checks.

FIG. 1 shows how typical private sector volunteer background checks are processed. The end product is a compiled, comprehensive report that includes, in addition to the criminal data from a commercial criminal history database, information on the volunteer's current and previous residence addresses, whether a Social Security number has been issued, any other names, for example, maiden and/or married names, associated with the SSN, and whether the volunteer's SSN is currently in use by other individuals.

The Federal Trade Commission considers volunteers to be a form of employee, so §607(b) of the Fair Credit Reporting Act (FCRA) applies to background checks of them. Specifically, that paragraph states, “Whenever a consumer reporting agency (for example, a professional background screening company) prepares a consumer report it shall follow reasonable procedures to assure maximum possible accuracy of the information concerning the individual about whom the report relates.”

When a query of a commercial criminal history database returns a record based upon a match of a volunteer's name and date of birth with an offender's name and date of birth, “reasonable procedures” typically involve additional on-site research of court records to assure that the record applies to the volunteer. Matches that apply to someone who is not the volunteer are called “false positives.” With continued reference to FIG. 1, the processing of typical private sector volunteer background checks is performed as follows:
(1) The Volunteer applies for a position with an organization that performs criminal history background checks on its volunteers.
(2) The Volunteer Organization submits the background check order to its Professional Background Screening Company.
(3) The Professional Background Screening Company submits a Volunteer Screening Request to the Database Compiler.
(4) The Database Compiler's system performs the following checks:
   The volunteer's SSN is checked for validity, date of issuance, maiden and/or married names associated with the SSN and if it is currently in use by other individuals.
   The volunteer's current and previous addresses are determined using the volunteer's SSN.
   The volunteer's criminal history record is compiled from criminal history database.
(5) The Database Compiler generates the Volunteer Screening Report for the Professional Background Screening Company.
(6) The Professional Background Screening Company: (1) verifies that the results apply to the Volunteer, (2) conducts on-site court searches as indicated by the address search, (3) evaluates the results and reviews the Volunteer Screening Report, (4) optionally, performs a Suitability Determination for the Volunteer Organization and (5) interprets the background check results for the Volunteer Organization. The Volunteer Organization orders additional searches using other names the Volunteer has used, such as married or maiden names, if they are found during the address check.

### Automated False Positive Elimination

Means for automating the “reasonable procedures” for eliminating many false positives have been recently developed, reducing the need for additional research to ensure that records apply to the volunteers. Examples of such means may be found in U.S. patent application Ser. No. 10/861,966 filed on Jun. 4, 2004 entitled, Systems, Apparatus and Methods for Performing Criminal Background Investigations, which is incorporated herein by reference in its entirety with permission of assignee National Background Data, LLC. These systems will be implemented when name checks return criminal history records that potentially apply to the volunteer. As shown in FIG. 2, these enhanced name checks include three basic types of database queries:
1) A query set of an address information database based upon an initial query using the volunteer's social security number (to identify any other names the volunteer may have used, for example, a married woman's maiden name) and a subsequent query of that results set using name and date of birth (to eliminate returned records with name and address data for a totally different person that had been incorrectly entered and recorded in the address information database using the volunteer's SSN).
2) A query of the criminal history database based upon each unique variation of the volunteer's first and/or last names and date of birth to find those criminal history records that correspond to those name variations (and therefore possibly the volunteer) and the state where each such record is located.
3) A query of the address information database based upon each unique variation of the volunteer's first and last names and date of birth in the criminal history records returned by Query 2) above to identify address records associated with others who have the same first and last names and dates of birth as the volunteer.

Queries 1) and 2) are part of the current basic volunteer checks and reflect current best practice in the professional background screening industry. Query 3) selects additional information about the volunteer and others with the same names and date of birth that can be automatically compared. The automated decision logic is based upon the following premises:
1. If the volunteer was the only person with the volunteer's name and date of birth who resided where a returned criminal history record was generated, there is reasonable assurance that the returned record applied to the volunteer.
2. If at least one person with the volunteer's name and date of birth resided where a returned criminal history record was generated, but the volunteer did not reside there, there is reasonable assurance that the returned record did not apply to the volunteer.
3. If at least one other person (in addition to the volunteer), with the same name and date of birth, resided where a returned criminal history record was generated, additional research is needed to determine whether the returned record applied to the volunteer.

Suitability determinations are the same for all of these volunteer checks. The money saved by avoiding manual research is expected to offset the additional cost associated with the second address information database query and the automated decision analysis.

### Public-Private Sector Partnerships in Support of Volunteer Checks

Public-private sector partnerships offer a way to make background checks of volunteers more effective and efficient by:
Adopting a volunteer centric model instead of the current organization centric model to ensure that the data provided to volunteer organizations only includes information that applies to the volunteers, and is reportable.
Supplementing fingerprint-based state repository and NCIC checks with commercial criminal history database name checks to search the data from other states that was not sent to the NCIC.
Providing low cost periodic re-screening of volunteers using commercial criminal history databases, when fingerprint-based checks have been recently conducted.

### Organization Centric Model

Both types of volunteer checks described so far and the public sector criminal history repository fingerprint-based background checks of volunteers are organization centric. In other words, the volunteer organization is arranging for the check and is provided the results in advance of the volunteer. Although the volunteer has certain rights, either under the FCRA in the case of the private sector checks, or the PROTECT Act in the case of the pilot programs, potentially erroneous results are returned to the volunteer organization before the volunteer has a chance to challenge their accuracy or reportability. In close knit communities of neighbors typically associated with volunteers, it is not reasonable to expect that volunteers will enjoy the same level of confidentiality of background check results normally afforded prospective employees under the FCRA.

The lack of portability of the results is another important limitation of the organization centric model. It places undue burden upon the volunteers, requiring them to complete end-to-end fingerprint-based background check processes for each volunteer organization. This lack of portability is particularly a problem for volunteers who have several children, each of whom participates in a variety of activities organized by different volunteer organizations.

### Volunteer or Individual Centric Model

A volunteer centric model supports the security and privacy protection afforded by fingerprint-based background checks, while minimizing the burdens placed on volunteers. The volunteers initiate their checks under the Freedom of Information Act (FOIA). In doing so they control access to their information. Volunteers share the results of the checks with the volunteer organizations only if they are comfortable doing so.

The volunteer centric model provides flexibility for volunteer organizations. They can rely on a trusted, independent third-party repository to validate the CHRI provided by volunteers using: (1) fingerprint validation devices or (2) the volunteers' photographs that the third-party repository maintains with their fingerprints.

### Volunteer Initiated Checks

Public-private partnerships will be required for the private sector to develop some of the volunteer centric solutions. As shown in FIG. 3, these solutions would integrate private sector name check screenings with fingerprint-based state repository and FBI NCIC checks facilitated using an independent third-party repository. The private sector name checks are also included because some volunteer organizations may still be relying on commercial name-based checks. In addition, their multi-state criminal history databases may contain data from other states that was not sent to the NCIC. By using a trusted, independent third-party biometric repository as an intermediary, volunteers have assurance that their fingerprints and the summaries of the results of their background checks will be released and used only with their specific authorization. Multiple volunteer organizations can use the services of the independent, trusted third-party repositories to validate the results of the volunteers' background checks, minimizing the need for repeated, expensive fingerprint-based volunteer checks. Volunteers could initiate their checks at Volunteer Processing Service Providers that are:
Offering the fingerprint-based background checks for employment purposes, or
Supported by professional background screening companies, for example, parks and recreation departments that serve multiple volunteer-run activities for children, or
Established specifically to offer Personal Identity Management services.

### Personal Identity Management

Implementation of a Volunteer Centric Model is the start of a much larger paradigm shift for the industry—Personal Identity Management. Background checks focus on rooting out the proverbial “bad apple” in the apple barrel. Commercial identity management companies are being organized to enable the next logical extension of the paradigm. The vast majority of volunteers want to be known as “good apples”. They want the organizations and people they deal with to understand that they are upstanding (albeit sometimes imperfect) citizens. These “good apples” are willing to expend effort to document their bona fides, or credentials.

Methodologies for individuals to monitor and release their financial information through independent third-parties (i.e., the three credit bureaus) are already in place. Personal Identity Management services will leverage these and other technologies to provide individuals the ability to monitor and control access to information that personally identifies them, such as financial, employment, educational, criminal history, and other types of records, in order to provide a complete picture of who they are, allowing them to prove through a trusted third party that they are suitable to be a volunteer, a good business partner, a trustworthy employee, etc. As the use of fingerprint-based background checks has emerged, acceptance of “electronic” signatures, or biometrics, has gained increased acceptance with consumers. Associating information with “layered biometrics” to ensure uniqueness can eventually become a major deterrent to identity theft. FIG. 3 illustrates an example of how such volunteer initiated checks may be performed and subsequently validated by the volunteer organization receiving the results of the criminal background investigation. This process is more thoroughly described in a U.S. patent application Ser. No. 10/883,114 filed by Robert W. Holloran, Michael M. Powers, George R. Boraiko and Alan L. Thomas on Jun. 30, 2004 and entitled Validation of Fingerprint-Based Criminal Background Check Results, which is incorporated herein by reference in its entirety with permission of the assignee, Credential Services, LLC. The process of FIG. 3 is described as follows:
(1) Volunteers request their Criminal History Record Information (CHRI) at a Volunteer Processing Service Provider with Freedom of Information Act (FOIA) requests supported by capture of their fingerprints and photographs.
(2) The Volunteer Processing Service Provider submits the Volunteers' fingerprints, photographs and background check orders to the Third-Party Repository's Core Processing Application Suite CPAS.
(3) The Third-Party Repository submits name check orders to a private sector Database Compiler to identify the Volunteers' criminal record histories contained in its commercial criminal history database with periodic re-screenings.
(4) The Database Compiler returns the results of the initial name check screening to the Volunteers and changes that occur when the number of offense reports changes during the periodic re-screenings.
(5) The Database Compiler returns summary results to the Third-Party Repository's CPAS.
(6) The Volunteers' fingerprint-based criminal history orders, along with their fingerprints and photographs, are stored in the Third-Party Repository's database.
(7) The Third-Party Repository submits the Volunteers' fingerprint-based criminal history FOIA requests to the applicable State Criminal History Repository and the FBI's NCIC.
(8) The State Repository and NCIC return summary results (the number of offender records identified) to the Third-Party Repository.
(9) The Third-Party Repository saves the summary results for use in validating the authenticity of the CHRI results the Volunteers provide to Volunteer Organizations for use in determining the Volunteers' suitability to volunteer.
(10) The State Repository and NCIC return the Volunteers' CHRI to them.
(11) The Volunteers submit their CHRI to the Volunteer Organizations for use in determining the volunteers' suitability to volunteer, providing they are comfortable with sharing the results.
(12) The Volunteer Organizations use Fingerprint Validation Devices to capture comparison fingerprints from the Volunteers, use a web browser to obtain their Order Numbers and send Validation Requests to the Third-Party Repository's AFIS for validation of the fingerprints used for the background check. The Third-Party Repository's AFIS performs a one-to-one comparison between the validation fingerprint(s) and the fingerprints retained in its AFIS Fingerprint Database that were used for the background check and returns a response to the Volunteer Organizations. A positive response (wherein the fingerprints match) validates to the Volunteer Organizations that the Volunteer's fingerprints were submitted for that order, thus positively linking the Volunteer and the CHRI rapsheet. A negative response indicates a likelihood that someone else's fingerprints may have been submitted and further investigation by the Volunteer Organizations is required. If the Volunteer Organizations do not have a Validation Device, the Volunteers' photographs are used to validate the results presented.
(13) The Suitability Review Agency makes suitability determination based upon the validated CHRI provided by the Volunteer.

### SUMMARY OF THE INVENTION

The subject invention relates to methods of conducting biometric-supported name-based criminal history background checks which employ the cooperative efforts of a professional background screening company, a database compiler, a trusted and independent third-party evaluator of biometric data, and at least one government criminal history repository. Three examples of how these entities work together to provide a screening solution are disclosed in detail below.

The primary characteristics of the subject method of conducting biometric-supported name-based criminal history background checks may be summarized as follows:
Accuracy—As described above, biometric-supported name-based checks permit improved identification accuracy over conventional name-based checks. However, it should be recognized that fingerprint-based checks are still more successful in identifying an individual that has created a completely new identity than a name-based check of a criminal history repository's fingerprint-based database.
The content accuracy of the records returned by the type of biometric-supported name-based checks envisioned by this paper would be the same as for fingerprint-based checks conducted for the same purpose. In both cases the applicable state repository would be returning an identical rap sheet.
Completeness—The biometric-supported name-based criminal history background check method of the subject invention may query the databases of the FBI, the state repositories and the private sector. The inherent technical advantage of fingerprint-based searches does not apply when fingerprint-based offender and offense records are not available in the fingerprint-based database that is being searched. For example, the FBI's database does not include offenders' fingerprint images that were not accepted, either because the prints did not meet its quality standards, or were associated with offenses that were below the FBI's severity threshold at the time. More importantly, the FBI's database includes only about 40% of the offense records, with the remainder available only at the applicable state criminal history repositories. Thus, a name-based check of a database that included the missing records would return records that would be missed by a fingerprint-based search of the FBI's database.

Even when a fingerprint-based check of the applicable state repository and a fingerprint-based check of the FBI's database is conducted, some offense records that are available only at other state repositories will not be returned for non-criminal justice background checks, even if there is a match with the offender's fingerprints in the FBI's database. Specifically, the offense records maintained by the states that have not ratified the Interstate Crime Prevention and Privacy Compact or signed the MOU with the Attorney General are not accessible for non-criminal justice purposes. It should be noted that all of the states' offense records are returned when either name- based or fingerprint-based checks are conducted for criminal justice purposes.

It could be argued that a name-based check conducted for criminal justice purposes would be more complete in terms of having fewer false negatives than a fingerprint-based check of a single state repository and the FBI's database conducted under the current restrictions on checks for non-criminal justice purposes. The completeness of such a biometric-supported name-based check would be further enhanced when private sector criminal history databases are checked, since they include name-based records maintained by courts for offenses for which the offenders' fingerprints were not captured and thus are not present in either the state repositories or the FBI's fingerprint-based databases.

Moreover, the biometric-supported name-based criminal record background checks of the subject invention avoid many of the practical barriers to wider use of conventional fingerprint-based checks:
Timeliness—The results of biometric-supported name-based checks are more timely, since the biometrics are captured by the employer and the vast majority of checks do not require use of the biometrics and those that do only require a one-to-one comparison.
Cost—The results of biometric-supported name-based checks are less expensive, since the employer can easily capture the required biometrics and the “no hit” checks (typically 90% when full dates of birth are available) do not require use of the one-to-one biometric comparisons.
Privacy—Biometric confirmation that the results apply to the subjects of the checks protects applicants, which is a frequently stated reason for using fingerprint-based check in lieu of name-based checks. With biometric-supported name-based checks, access to the applicant's biometrics is restricted. For example, they cannot be used in conjunction with criminal investigations. Also, employers would always receive the results from a CRA, the FCRA's restrictions on dissemination of the results apply, ensuring protection of the applicants' privacy.
Convenience—Since the employer captures the required biometrics, it is not necessary for the applicant to travel to another facility to be fingerprinted. Furthermore, there is no opportunity for the fingerprints of someone other than the intended applicant to be substituted, as currently exists, when someone other than the employer captures the prints or when the person being printed is given custody of the completed fingerprint card. The special “breeder document” controls being developed by the Compact Council's Standards Committee to ensure the correct person is being printed are not necessary when the employer captures the prints.
Capacity/Scalability—Biometric-supported name-based checks leverage the existing professional background screening industry's extensive order processing, employer support and criminal history database infrastructure. The government criminal history repositories' AFIS capabilities are not impacted, since all requests for offender biometric and offense data will be based upon the offenders' record identifiers and will leverage existing protocols the repositories currently support for interagency transfers of biometric data and rapsheets. The Trusted, Independent Third-Party Evaluator's biometric matching infrastructure is based upon one-to-one matches, so it is not computationally intensive and is easily scalable.
Security—The person requesting a biometric-supported name-based check can be required to submit one of his/her own fingerprints, as well as two fingerprints and a digital photograph of the applicant. These submissions reduce the potential for criminal history records to be obtained without authorization.
Literacy—In addition to increased security, requiring the people who request biometric-supported name-based checks to provide one of their own fingerprints, increases accountability. The interactive interface when the biometrics are captured provides an opportunity to inform applicants of their rights with regards to the background check and its results.

By addressing some of the concerns about name-based checks that are frequently expressed by government criminal history repository personnel, biometric-supported name-based criminal history background checks may permit increased name-based checks of both state and federal criminal history repository data in ways that would provide these repositories needed revenue with minimum impact on their personnel and infrastructure.

A trusted, independent third-party evaluator ensures that applicants' biometric information is used only for the intended background screening purpose and cannot be used by government agencies for crime scene investigations or for commercial purposes.

There has thus been outlined, rather broadly, the more important features of the invention in order that the detailed description thereof that follows may be better understood, and in order that the present contribution to the art may be better appreciated. There are, of course, additional features of the invention that will be described hereinafter. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that this disclosure be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, nor is it intended to be limiting as to the scope of the invention in any way.

It is, therefore, a primary object of the subject invention to provide a means for improving the identification accuracy of name-based criminal history background checks through the use of biometric information.

It is also a primary object of the subject invention to increase the use of biometrics in private sector criminal history background checks, while avoiding the timeliness, cost, inconvenience and privacy barriers associated with traditional fingerprint-based criminal history background checks.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying descriptive matter in which there is disclosed preferred embodiments of the invention.

### BRIEF DESCRIPTION OF THE DRAWINGS

FIG. 1 is a diagram illustrating how typical private sector volunteer background checks are processed;

FIG. 2 is a diagram illustrating an automated false positive elimination process;

FIG. 3 is a diagram illustrating a volunteer initiated criminal background investigation with subsequent volunteer organization validation of the investigation results;

FIG. 4 is a diagram illustrating an employment screening solution of the subject invention that uses biometrics to eliminate false positive results;

FIG. 5 is a diagram illustrating a fingerprint-supported name-based criminal history background check process of the subject invention that relies on a private sector criminal history database; and

FIG. 6 is a diagram illustrating a fingerprint-supported name-based criminal history background check process of the subject invention that queries multiple public-private sector criminal history databases.

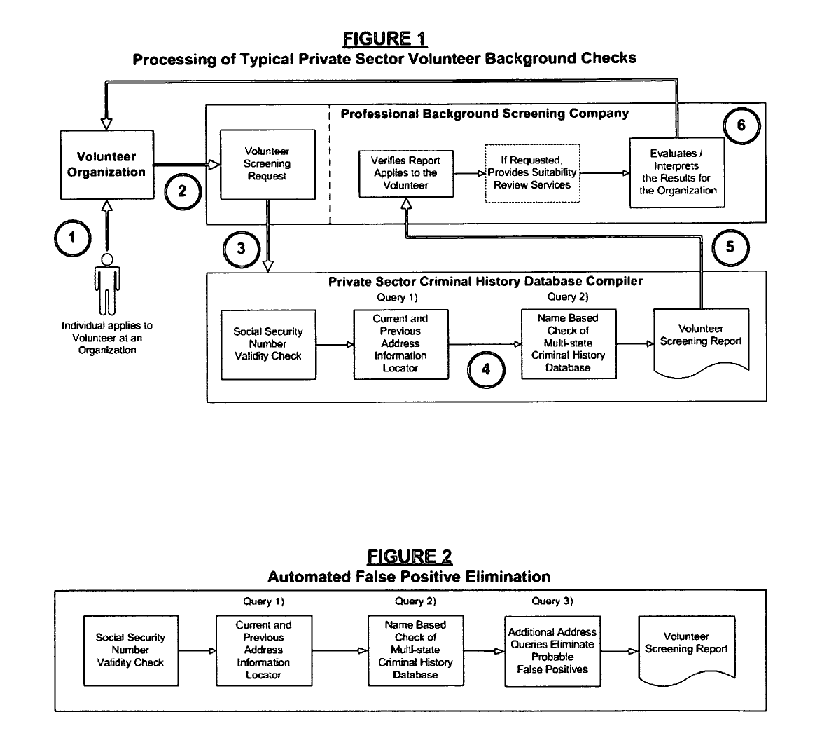

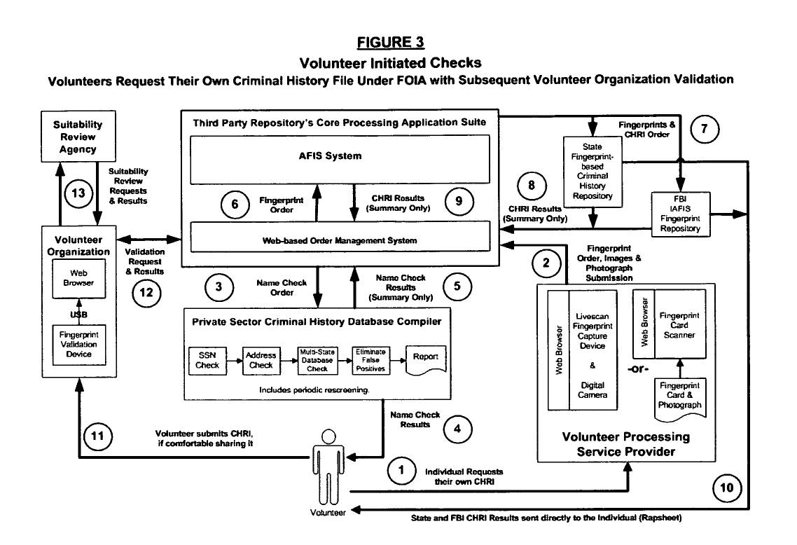

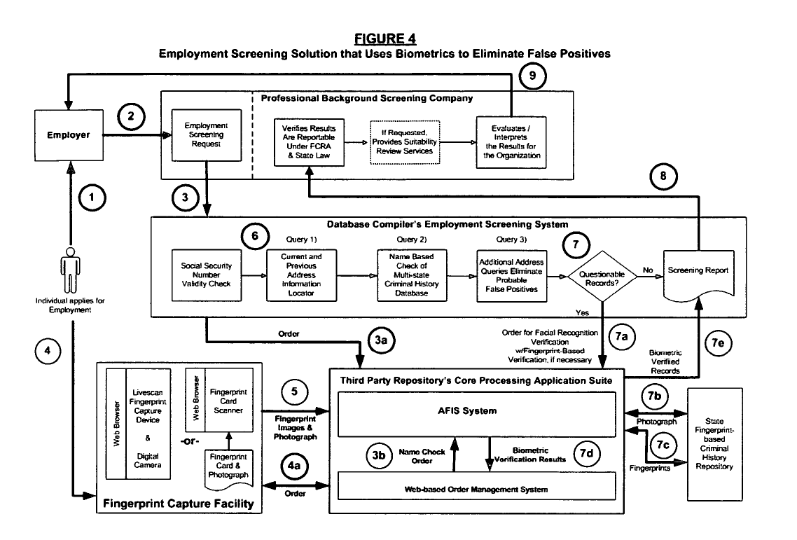

### DETAILED DESCRIPTION OF THE INVENTION

The subject invention relates to methods of conducting biometric-supported name-based criminal history background checks which employ the cooperative efforts of a professional background screening company, a database compiler, a trusted and independent third-party evaluator of biometric data, and at least one government criminal history repository. Three examples of how these entities work together to provide an enhanced screening solution will now be described.

### EXAMPLE 1

### Conducting Biometric-Supported Name-Based Checks

FIG. 4 illustrates a first embodiment of the subject method of performing a biometric-supported name-based criminal history background check on an individual, such as a prospective employee, wherein said biometric data is comprised of photographs and, if necessary, fingerprints used to eliminate false positives. These checks could start with a fingerprint-based state repository check (not shown). The subject employment screening solution is performed as follows:
(1) The Individual applies for a job at the Employer's facility and authorizes the Employer to conduct a criminal history background check, self-reporting any previous criminal convictions.
(2) The Employer places order for a criminal history background check through its Professional Background Screening Company.
(3) The Professional Background Screening Company forwards the Employer's criminal history background check to the private sector Database Compiler.
(3a) The Database Compiler submits order to the Third-Party Repository to capture the Applicant's fingerprints and take the Applicant's photograph.
(4) The Employer directs the Applicant to the Fingerprint Capture Facility to have the Applicant's fingerprints captured and photograph taken. Alternatively, and as will be demonstrated in the subsequent embodiments described below, the Employer may capture this biometric data itself on site or at a remote facility.
(4a) The Fingerprint Capture Facility obtains the order from the Third-Party Repository's website.
(5) The Fingerprint Capture Facility captures the Applicant's fingerprints and takes the Applicant's photograph and submits them to Third-Party Repository's Core Processing Application Suite.
(6) The Database Complier runs the enhanced name check which includes:
   A Social Security Number Verification Check
   Query 1) An address check based upon Applicant's SSN
   Query 2) A criminal background check of Database Complier's multi-state criminal history database using the names and dates of birth returned by Query 1).
   Query 3) An address check based upon Applicant's name and date of birth for each offender record returned by Query 2) followed by its decision logic to eliminate false positives.
(7a) If the results of the decision logic are inconclusive, the Database Compiler submits an order to the Third-Party Repository for a Facial Recognition comparison between the Applicant's photograph and the offender's mug shot in the applicable State Repository.
(7b) The Third Party Repository obtains the offender's mug shot from applicable State Repository for comparison with Applicant's photograph using the Third Party Repository's automated facial recognition software. (7c) If facial recognition software results indicate that the Applicant may be the offender, the Third Party Repository's AFIS system submits the Applicant's fingerprints to the State Repository for a one-to-one comparison with the offender's fingerprints.
(7d) The Third Party Repository's AFIS system updates the its Web-based Order Management System with the results of the state repository's verification.
(7e) The Third Party Repository's Web-based Order Management System reports the results of the facial recognition comparison and, if applicable, the fingerprint comparison results to Database Compiler's Employment Screening System.
(8) The Database Compiler's Employment Screening System returns the results to the Professional Background Screening Company.
(9) The Professional Background Screening Company evaluates the results for the Employer and, if required by contract, evaluates suitability of the Applicant against criteria established by the Employer.

As may be appreciated from the above description, the subject invention provides a means for improving protection of individuals' privacy through: (1) biometric verifications which reduce false positives from name-based checks, and (2) a background check paradigm that places them in the center of the process. Under this paradigm, individuals monitor and manage access to the public and private information that reflects important aspects of their life history. This information is used by others to evaluate the individuals' suitability as volunteers in support of children and other vulnerable populations, as well as for employment and other positions of trust.

The subject invention enables individuals to ensure that the information is accurate and complete prior to its release to others. However, a trusted third-party repository's validation process ensures that fingerprint-based criminal history background checks actually apply to the individuals and the results the individuals present are authentic.

The subject invention enhances security by: (1) facilitating the use of fingerprint-based criminal background checks and (2) using private sector name based checks to supplement state repository checks in other states when NCIC checks are not authorized. Even when NCIC checks are conducted, private sector criminal history databases can be a valuable supplement to the NCIC checks. It is generally acknowledged that the NCIC is not as complete as state repository data. Also, the Interstate Identification Index System data maintained by the states that have not ratified the Interstate Crime Prevention and Privacy Compact or signed the MOU with the Attorney General is not accessible for non-criminal justice purposes.

### EXAMPLE 2

### Conducting Biometric-Supported Name-Based Checks with a Private Criminal History Database

Two types of the applicants' biometrics are captured by employers and used, as necessary, by the Trusted, Independent Third-Party Evaluator to determine whether the “hits” apply to the applicant:
One or two “flat” fingerprints are captured in a way that supports one-to-one matching with the offenders' rolled print images that are retained by repositories.
A digital photograph is taken under controlled conditions that support facial recognition matching with offenders' mug shots.

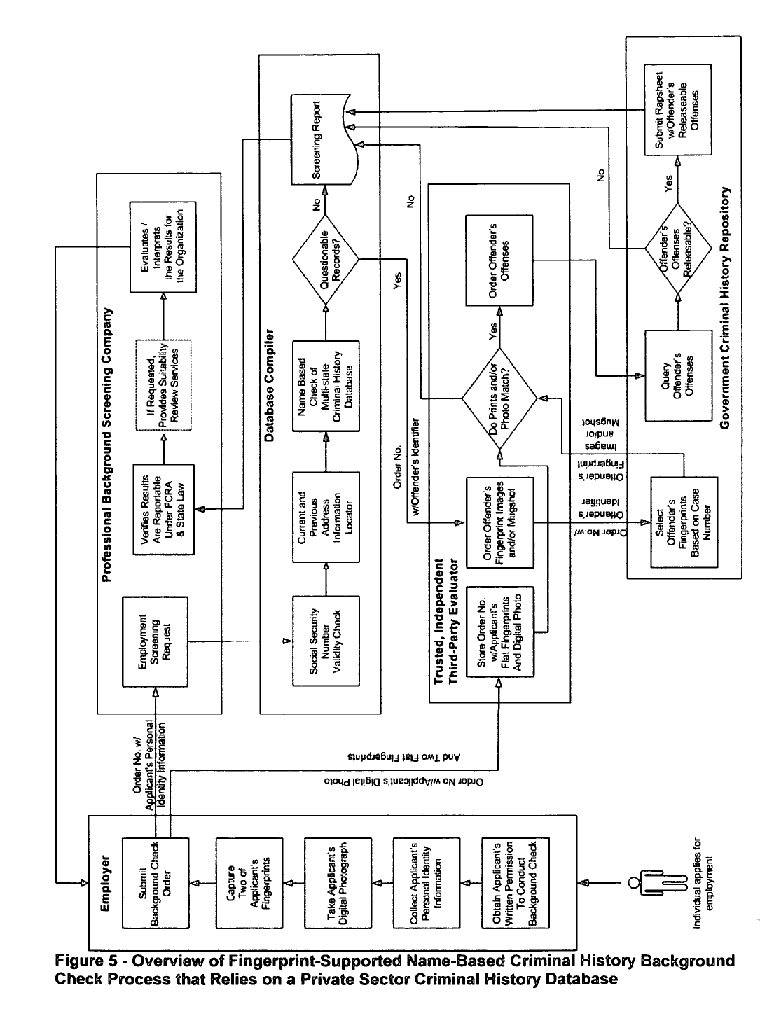

FIG. 5 provides a high-level flowchart of a second embodiment of the subject method of conducting biometric-supported name-based checks. The method includes the following six basic phases:
1. Employers collect the biometrics and demographic information from the applicants, order the background screenings and submit the biometrics with a unique order number to the Trusted, Independent Third-Party Evaluator.
2. Professional background screening companies (CRAs) and their database compilers check the accuracy of demographic information collected by the employers and conduct other types of employment background checks, such as, reference checks, employment and educational verifications (not shown), and conduct name-based searches of the database compiler's multi-state criminal history database, supplemented with on-site court checks in jurisdictions where the applicants lived that are not adequately covered by the multi-state criminal history database. If there are no “hits” during these checks, screening reports are prepared and returned to the employers with explanatory information permitting them to interpret the results and understand the inherent limitations of the searches.
3. Database compilers submit the Order Number and the returned offender's identifiers associated with the hits and the jurisdictions where the hits occurred to the Trusted, Independent Third-Party Evaluator for evaluation.
4. The Trusted, Independent Third-Party Evaluator obtains offenders' biometrics (fingerprints and/or mug shots, as available) from the government criminal history repositories holding the offenders' records for comparison with the applicant's biometrics.
5. The Trusted, Independent Third-Party Evaluator orders the releasable offense records associated with the hits from the government criminal history repositories that hold the records when the applicants' biometrics match the offenders' biometrics.
6. Professional background screening companies (CRAs) generate Consumer Reports based upon the records returned by the applicable repositories via the database compilers, provide the Consumer Reports to the employers and notify the applicants, when required by the FCRA. In the event that the offenders' fingerprints and/or mug shots are not available in the jurisdiction of record's criminal history repositories, the professional background screening companies take other measures to determine whether the offenses reasonably apply to the offenders. In addition, the professional background screening companies are responsible for obtaining any missing dispositions in the offense records returned by the government criminal history repositories.

### Essential Technical Elements of Biometric-Supported Name-Based Checks

Although the cost of rolled-print live scan equipment and software has become less expensive over the past several years, rolled-print live scan equipment is still too expensive, is too time consuming to use and requires too much operator training for most employers. Scanners and software for capturing flat fingerprints are less expensive, easier to use, take less time to complete the capture than rolled-live scan devices and have been approved for making submissions to the FBI. However, the Ohio Bureau of Identification and the FBI are currently the only government criminal history repositories that are accepting submission of flat fingerprints for civil purposes.

The flat fingerprint-capture devices and software used by employers to conduct the biometric-supported name-based checks envisioned by this paper must have the following characteristics:
Inexpensive, ideally, the flat fingerprint capture device and the digital camera should cost the employer no more than a few hundred dollars.
Easy to use, requiring little training to capture usable flat prints in less than 15 seconds.
Self-checking to ensure that the captured prints and digital photographs are of acceptable quality. As an alternative, this quality control could take place on the Trusted, Independent Third-Party Evaluator's system, provided real-time notification appears on the employer's system if the quality is not adequate, so the defective biometrics can be recaptured while the applicant is still present.
Web-based, using SSL forms for secure transmission.
Interface with existing desktop computers used by HR departments, preferably, via a USB port.
Interact with applicants for the purpose of informing them of their rights and to obtain their authorization to use their biometrics for the purpose of conducting biometric-supported criminal history background checks.
Generate a unique order number for each applicant's biometrics that is submitted with the biometrics to the Trusted, Independent Third-Party Evaluator and with the background check order to the professional background screening company, so any hits and demographic information submitted to the Trusted, Independent Third-Party Evaluator can be accurately matched with the applicant's biometrics.
NIST compliant submission of the flat prints and digital photographs.

The system used by the Trusted, Independent Third-Party Evaluator to determine whether offender records returned by name-based checks apply to the applicant must have the following characteristics:
Accurately compares fingerprints to determine whether the submitted flat fingerprints match the fingerprint images received from the repositories.
Accurately compares facial photographs to determine whether the submitted digital photograph matches the offender's mug shot received from the repositories.
Securely protects both the biometric data and the integrity of the process.
Destroys the biometric data not used for comparison with returned offender records.
Securely retains applicants and offenders' biometric data used to determine that the returned offender records apply to the applicants, as required by applicable laws, such as the FCRA and Sarbanes-Oxley, for use in the event the determinations of applicability are challenged by applicants, when the applicants were determined to be the offenders, or injured parties, when the applicants were determined to not be the offenders.

To minimize the potential for identity theft the Trusted, Independent Third-Party Evaluator does not receive, store or use the applicants and offenders' demographic data. The offenders' demographic information that is embedded in mug shots is not used, nor is it searchable. All of its matches are biometric based. The system generated Order Number is used to link the applicant's biometrics with the offenders' biometrics that are submitted by the repositories.

### Other Uses of the Technical Elements

The inexpensive flat fingerprint-capture devices and web-based software for submitting individual flat fingerprints have other important uses:
Validating the intended applicant's fingerprints were used to conduct fingerprint-based background checks.
Authorizing individuals who submit background-screening requests based upon fingerprints captured during enrollment to ensure that everyone who submits requests is authorized to do so.
Documenting with a biometric, individuals who submit background-screening requests for use in prosecuting criminal and civil cases against anyone who submits unauthorized requests.

### Essential Characteristics of the Trusted, Independent Third-Party Evaluator

Because of the sensitive nature of individuals' biometric information, to be accepted the evaluator must be able to demonstrate that it is trustworthy to the public, the individuals whose biometric information it handles, the government agencies that provide offenders' biometric to it, the professional background screening industry and the end-users who rely on the results of its determinations. To earn this trust:
Its only role is to reliably determine whether applicant's biometrics match offenders' biometrics in such a way that the information entrusted to it cannot be used for any other purposes.
It needs to be independent of those who could use the information for other purposes.
It should only receive applicants' biometric data, without any personal identifiers, so there will be little potential for the data to be misused.
It needs strong network and physical security to ensure integrity of the process and protect the repositories and professional background screening company systems with which it connects.

### EXAMPLE 3

### Conducting Biometric-Supported Name-Based Checks Using Public and Private Criminal History Databases

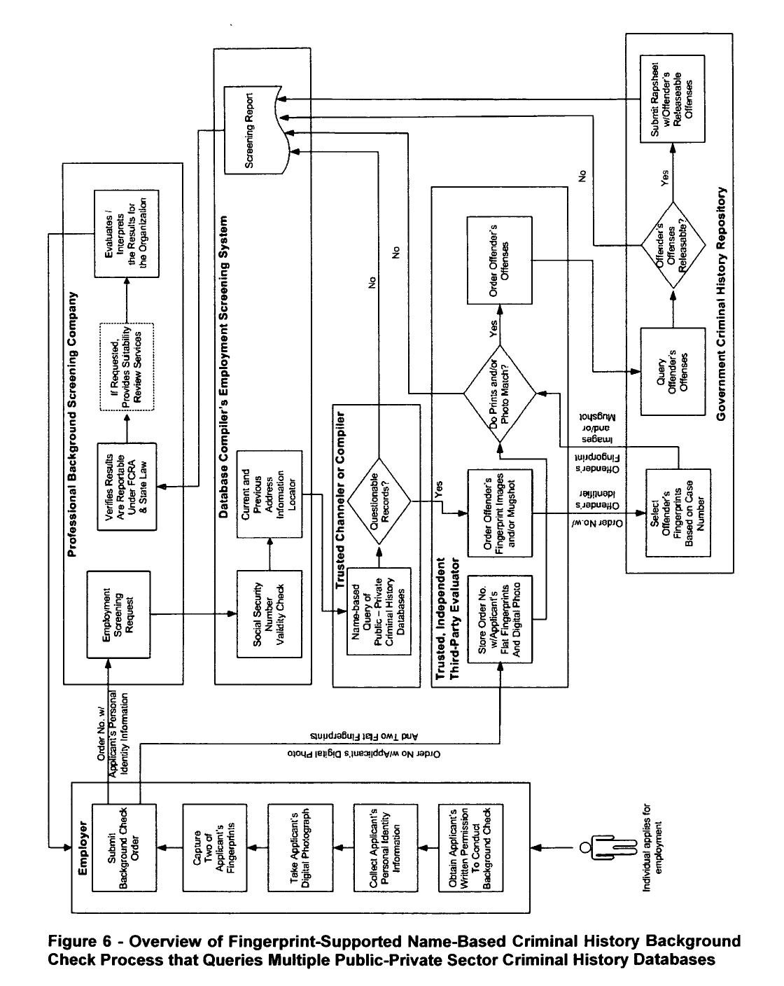

FIG. 6 provides a high-level flowchart of a third embodiment of the subject method of conducting biometric-supported name-based checks that draw upon the offender indexes of both public and private criminal history databases. The primary difference in the processes shown on FIGS. 5 and 6 is the addition of a “Trusted Channeler or Compiler” that would channel name-based queries to the repositories, or conduct the name-based checks of the public and private offender indexes. Two basic approaches are possible:
1. A Trusted Channeler could act as a gateway to the existing offender indexes that reside on the repositories' servers.
2. A Trusted Compiler could compile, maintain and host a consolidated and normalized index of the offenders in the public and private criminal history database. This approach would permit consistent use of advanced matching logic to increase the probability of locating all of the applicants' offender records.
   Of course, a combination of these two approaches is also possible.

### Essential Characteristics of a Trusted Channeler or Compiler

Currently, there are many organizations; public and private, involved with background screening, which are channelers of background screening orders and results. Some of these are also compilers of criminal history databases. The FTC regulates the professional background screening companies as Consumer Reporting Agencies under the FCRA. They are restricted from using the applicants' information for any other purposes. Although many jurisdictions have provided bulk criminal history data with the offenders' dates of birth without any restrictions on its use, responsible criminal history database compilers use of the offenders' dates of birth only for matching purposes. They do not “publish the offenders' personal identity information on the Internet” so anyone can look up offenders' personal identifiers. To be a Trusted Channeler or Compiler:
Its only role is to reliably determine whether applicant's demographics match offenders' demographics in such a way that the information entrusted to it cannot be used for any other purposes.
It needs to be independent of those who could use the information for other purposes.
It should only receive applicants' personal identifiers, without any biometrics, limiting the extent to which the personal identifiers might be misused.
It needs strong network and physical security to ensure integrity of the process and protect the repositories and professional background screening company systems with which it connects.
It needs to have the infrastructure and credibility necessary to support the entire the professional background screening industry to limit the impact on technical and administrative infrastructures of the public criminal history repositories.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications.

What is claimed as being new, useful and desired to be protected by letters patent of the United States is as follows:

1. A method of conducting a biometric-supported name-based criminal background check on an individual, the method comprising the steps of:
a. The Individual applies for a job at the Employer's facility and authorizes the Employer to conduct a criminal history background check, self-reporting any previous criminal convictions.
b. The Employer places order for a criminal history background check with a Professional Background Screening Company.
c. The Professional Background Screening Company forwards the Employer's criminal history background check to the private sector Database Compiler.
d. The Database Compiler submits order to the Third-Party Repository to capture the Applicant's fingerprints and take the Applicant's photograph.
e. The Employer directs the Applicant to the Fingerprint Capture Facility to have the Applicant's fingerprints captured and photograph taken.
f. The Fingerprint Capture Facility obtains the order from the Third-Party Repository's website.
g. The Fingerprint Capture Facility captures the Applicant's fingerprints and takes the Applicant's photograph and submits them to Third-Party Repository's Core Processing Application Suite.
h. The Database Complier performs a name check which includes:
i. A Social Security Number Verification Check
ii. Query 1) An address check based upon Applicant's SSN
iii. Query 2) A criminal background check of Database Compiler's multi-state criminal history database using the names and dates of birth returned by Query 1)
iv. Query 3) An address check based upon Applicant's name and date of birth for each offender record returned by Query 2) followed by its decision logic to eliminate false positives.
i. If the results of the decision logic are inconclusive, the Database Compiler submits an order to the Third-Party Repository for a Facial Recognition comparison between the Applicant's photograph and the offender's mug shot in the applicable State Repository.
j. The Third Party Repository obtains the offender's mug shot from applicable State Repository for comparison with Applicant's photograph using the Third Party Repository's automated facial recognition software.
k. If facial recognition software results indicate that the Applicant may be the offender, the Third Party Repository's AFIS system submits the Applicant's fingerprints to the State Repository for a one-to-one comparison with the offender's fingerprints.
l. The Third Party Repository's AFIS system updates the its Web-based Order Management System with the results of the state repository's verification.
m. The Third Party Repository's Web-based Order Management System reports the results of the facial recognition comparison and, if applicable, the fingerprint comparison results to Database Compiler's Employment Screening System.
n. The Database Compiler's Employment Screening System returns the results to the Professional Background Screening Company.
o. The Professional Background Screening Company evaluates the results for the Employer and, if required by contract, evaluates suitability of the Applicant against criteria established by the Employer.
